(19) United States
(12) Patent Application Publication
(10) Pub. No.: US 2024/0135807 A1
(43) Pub. Date: Apr. 25, 2024

(54) IN-VEHICLE DEVICE

(71) Applicant: TOYOTA JIDOSHA KABUSHIKI KAISHA, Toyota-shi (JP)

(72) Inventors: Yoshinori YOKOYAMA, Yokohama-shi (JP); Yoshikazu TOYAMA, Tokyo (JP)

(73) Assignee: TOYOTA JIDOSHA KABUSHIKI KAISHA, Toyota-shi (JP)

(21) Appl. No.: 18/448,459

(22) Filed: Aug. 10, 2023

(30) Foreign Application Priority Data
Oct. 24, 2022 (JP) 2022-170888

(51) Int. Cl. G08G 1/01; G08G 1/0967

(52) U.S. Cl. CPC G08G 1/0145; G08G 1/012; G08G 1/0967

(57) ABSTRACT

The in-vehicle device mounted on the vehicle includes a control unit having a function of acquiring traffic congestion information for each lane on a road having a plurality of lanes and guiding the vehicle to another lane based on the acquired traffic congestion information, and when the vehicle travels in a predetermined section from the exit in a first lane connected to the exit from the road, the control unit cancels the function.

### CROSS-REFERENCE TO RELATED APPLICATION

This application claims priority to Japanese Patent Application No. 2022-170888 filed on Oct. 25, 2022, incorporated herein by reference in its entirety.

### BACKGROUND

### 1. Technical Field

The present disclosure relates to an in-vehicle device.

### 2. Description of Related Art

Japanese Unexamined Patent Application Publication No. 11-160081 (JP 11-160081 A) discloses a navigation method in which navigation control is performed by identifying which lane is congested in a highway link in which one lane is connected to a highway exit among two lanes of a highway or the like.

### SUMMARY

In the case of a system that acquires current traffic congestion information from a server, there may be situations where accurate information such as a leading position of the traffic congestion cannot be provided due to a time lag caused by information processing in the server or the like. When such a situation occurs near an exit of a highway or the like, there is a possibility that a vehicle cannot get off the exit due to an erroneous lane change guidance.

An object of the present disclosure is to enable suppressing erroneous lane change guidance even when the current traffic congestion information acquired by the in-vehicle device is not accurate.

An in-vehicle device according to the present disclosure is an in-vehicle device mounted on a vehicle. The in-vehicle device includes a control unit having a function of acquiring traffic congestion information for each lane on a road with a plurality of lanes and guiding the vehicle to another lane based on the acquired traffic congestion information. The control unit cancels the function when the vehicle travels within a predetermined section from an exit in a first lane that leads to the exit from the road.

According to the present disclosure, it is possible to suppress erroneous lane change guidance even when the current traffic congestion information acquired by the in-vehicle device is not accurate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram illustrating a schematic configuration of an information processing system including an in-vehicle device according to an embodiment of the present disclosure;

FIG. 2 is a flowchart for explaining an example of an information processing method executed by the in-vehicle device of FIG. 1;

FIG. 3 is a first view for explaining the background and problems of the prior art; and

FIG. 4 is a second diagram for describing the background and issues of the prior art.

### DETAILED DESCRIPTION OF EMBODIMENTS

The background and problems of the prior art will be described in more detail.

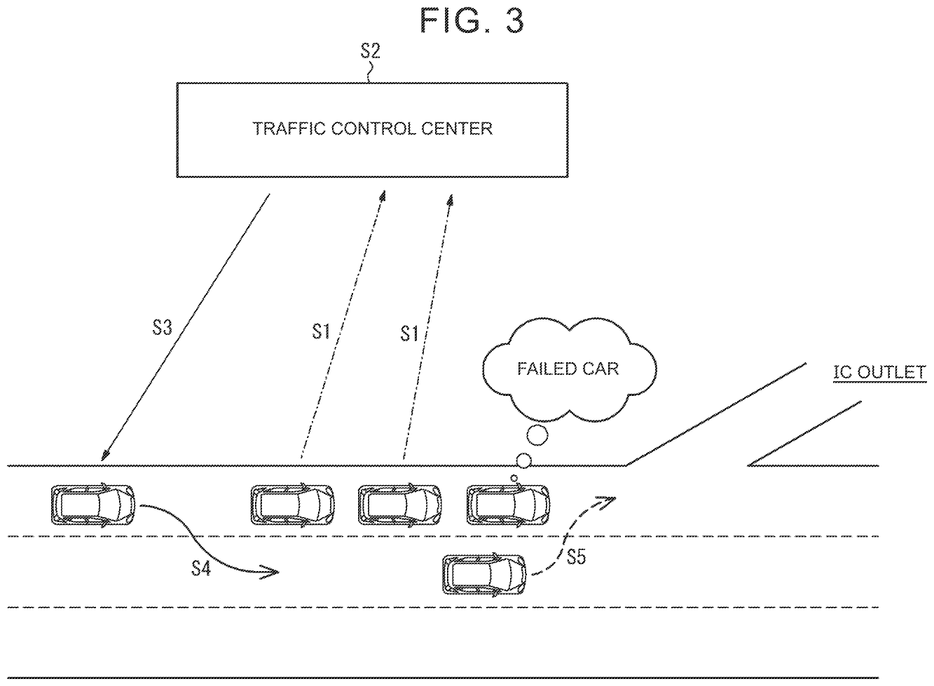

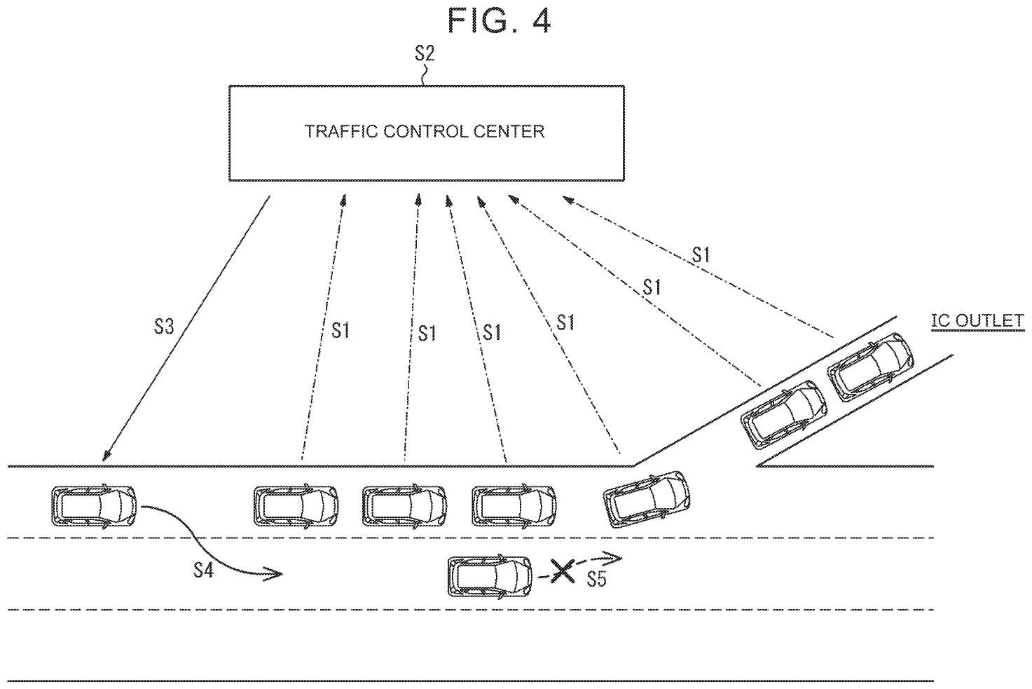

FIG. 3 is a first diagram for explaining the background and problems of the prior art. FIG. 4 is a second diagram for explaining the background and problems of the prior art. In the case shown in FIGS. 3 and 4, the vehicles, as an example, travel in a lane that leads to an Interchange (IC) exit of a plurality of lanes on an expressway that are scheduled to descend. It is assumed that a traffic jam occurs while the vehicle is traveling in the lane. FIG. 3 illustrates a situation where there is a leading position of a traffic jam in front of a branch point to an IC outlet at which vehicles are scheduled to descend. FIG. 4 shows a case where a leading position of a traffic jam is located ahead of the branch point. At this time, the driver driving the vehicle desires to improve the fuel efficiency of the vehicle by utilizing the traffic jam information for each lane provided to the vehicle from the traffic control center and avoiding the traffic jam for each lane.

In S1 of FIGS. 3 and 4, the traffic control center is notified of information indicating that the vehicle speed is slow and the traffic jam is occurring from the vehicles involved in the traffic jam among the plurality of vehicles traveling in the lane. In S2, the traffic control center detects a traffic jam on an expressway, specifies a leading position, a trailing position, and the like of the traffic jam, and generates traffic jam information including these positions. In S3, the traffic control center travels behind the traffic jam in the lane, and notifies the vehicle that is not involved in the traffic jam based on the traffic jam information that is generated when the traffic jam occurs at the destination of the lane. In S4, a vehicle traveling behind a traffic jam in the lane changes the lane based on the traffic jam data obtained from the traffic control center to avoid the traffic jam. In S5, the vehicles attempt to move to the original lane to get off IC outlet after changing lanes to avoid congestion.

In the above-described flow, it takes time to detect a traffic jam on an expressway, to generate traffic jam information at a traffic control center, and to distribute traffic jam information from the traffic control center to a vehicle, and the actual situation and the distributed traffic jam information may deviate from each other. For example, the presence or absence of a traffic jam included in the delivered traffic jam information and information such as an end position of the traffic jam may be different from an actual situation. This may prevent the vehicles from getting out of IC outlet due to erroneous lane change guidance.

For example, as shown in FIG. 4, even though the head position of the actual traffic jam is further ahead of the branch point to IC outlet which is going to descend, it is also assumed that the traffic jam information that the head position of the traffic jam is ahead of the branch point is distributed from the traffic control center. At this time, although the lane of the vehicle is changed in order to avoid a traffic jam, the vehicle cannot return to the original lane by the branch point, and consequently cannot get off IC outlet.

An object of the present disclosure is to provide an in-vehicle device capable of suppressing the above-described erroneous lane change guidance even when current congestion information acquired from a traffic control center by an in-vehicle device mounted on a vehicle is not accurate.

Hereinafter, an embodiment of the present disclosure will be described below with reference to the drawings.

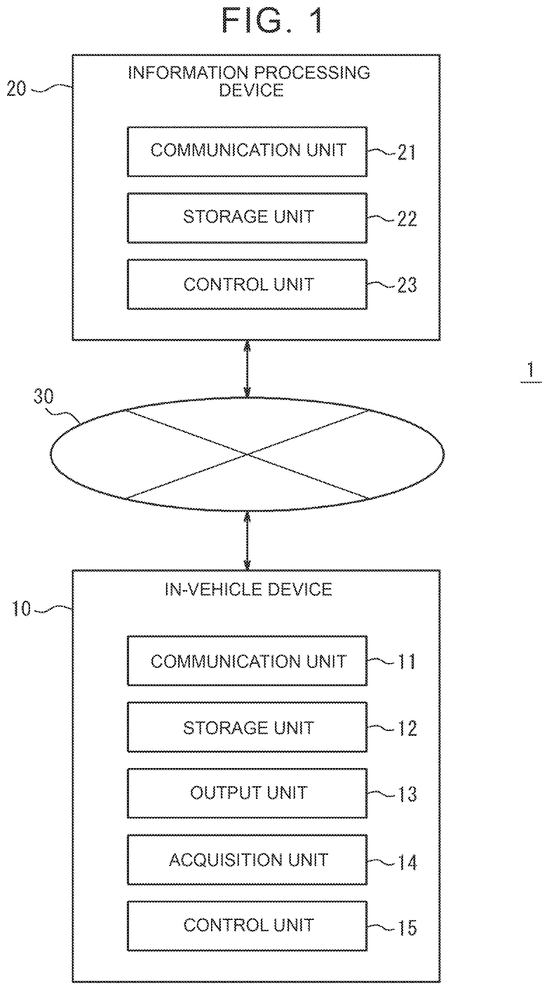

FIG. 1 is a functional block diagram illustrating a schematic configuration of an information processing system 1 including an in-vehicle device 10 according to an embodiment of the present disclosure. With reference to FIG. 1, an outline of an information processing system 1 including an in-vehicle device 10 according to an embodiment of the present disclosure will be mainly described. The information processing system 1 includes an information processing apparatus 20 in addition to the in-vehicle device 10. The in-vehicle device 10 is mounted on a vehicle.

In FIG. 1, only one in-vehicle device 10 is illustrated for convenience of explanation, and the in-vehicle device 10 is mounted and one vehicle is included in the information processing system 1, but the present disclosure is not limited thereto. The number of in-vehicle devices 10 included in the information processing system 1 may be two or more. That is, when one in-vehicle device 10 is mounted on one vehicle, the number of vehicles included in the information processing system 1 may be two or more.

Although only one information processing apparatus 20 is illustrated in FIG. 1 for convenience of explanation, the number of information processing apparatuses 20 included in the information processing system 1 may be two or more.

Each of the in-vehicle device 10 and the information processing apparatus 20 is communicably connected to a network 30 including a mobile communication network, the Internet, and the like.

The in-vehicle device 10 is a device that controls the traveling of the mounted vehicle or assists the driver in driving the vehicle. As an overview of an embodiment, the in-vehicle device 10 acquires traffic jam information for each lane on a road having a plurality of lanes. In the present disclosure, the “road” includes, for example, an expressway, a general road dedicated to automobiles, and the like. The “traffic jam information” includes, for example, information such as the presence or absence of a traffic jam, the distance of the traffic jam, the leading position of the traffic jam, and the trailing position of the traffic jam. The congestion information may include, in addition to the current first information, second information of the same day of the week and the same time in the past.

The in-vehicle device 10 has a function of guiding the vehicle to another lane based on the acquired congestion information. When the vehicle travels within a predetermined section from the exit in the first lane leading to the exit from the road, the in-vehicle device 10 releases the function.

Vehicles are any type of vehicle, such as a gasoline-powered vehicle, a diesel-powered vehicle, a hydrogen-powered vehicle, Hybrid Electric Vehicle (HEV), Plug-in Hybrid Electric Vehicle (PHEV), Battery Electric Vehicle (BEV), or Fuel Cell Electric Vehicle (FCEV). The vehicles may be Autonomous Vehicle (AV) or driven by a driver, or the driving may be automated at any level. The level of automation is, for example, any of level 1 to level 5 in the level division of Society of Automotive Engineers (SAE). The vehicle may be a Mobility as a Service (MaaS) dedicated vehicle.

The information processing apparatus 20 is managed by a traffic control center that distributes traffic information including traffic jam information and the like to a vehicle. The information processing apparatus 20 is one or a plurality of server apparatuses capable of communicating with each other. The information processing apparatus 20 is not limited thereto, and may be any general-purpose electronic device such as a mobile phone, a smart phone, or a mobile device such as a tablet, or a Personal Computer (PC), or may be any other electronic device dedicated to the information processing system 1.

An example of the configuration of each of the in-vehicle device 10 and the information processing apparatus 20 included in the information processing system 1 will be mainly described with reference to FIG. 1.

As illustrated in FIG. 1, the in-vehicle device 10 includes a communication unit 11, a storage unit 12, an output unit 13, an acquisition unit 14, and a control unit 15.

The communication unit 11 includes a communication interface communicably connected to the network 30. The communication interface includes, for example, an interface corresponding to a Dedicated Short Range Communications (DSRC), Electronic Toll Collection System (ETC) 2.0, or optical beacon. In addition, the communication interface may include an interface corresponding to a mobile communication standard such as a wired Local Area Network (LAN) communication standard such as Ethernet (registered trademark), a radio LAN communication standard such as Institute of Electrical and Electronics Engineers (IEEE) 802.11, or a Long Term Evolution (LTE), 4th Generation (4G) standard, or 5th Generation (5G). In one embodiment, the in-vehicle device 10 is communicably connected to the network 30 via the communication unit 11. The communication unit 11 receives data used for the operation of the in-vehicle device 10 via the network 30, and transmits data obtained by the operation of the in-vehicle device 10.

The storage unit 12 includes, for example, a semiconductor memory, a magnetic memory, an optical memory, or any combination thereof. The storage unit 12 may function as, for example, a main storage device, an auxiliary storage device, or a cache memory. The storage unit 12 stores data used for the operation of the in-vehicle device 10 and data obtained by the operation of the in-vehicle device 10. For example, the storage unit 12 stores a system program, an application program, various types of data received or transmitted by the communication unit 11, and the like. The data stored in the storage unit 12 may be updatable by, for example, data received from the network 30 via the communication unit 11.

The output unit 13 includes an output interface for outputting information to an occupant including a driver in a vehicle cabin. The output interface is, for example, a display or a speaker. Displays are, for example, Liquid Crystal Display (LCD) or organic Electro Luminescent (EL) displays. The output interface may form part of a car navigation device. The output unit 13 outputs, for example, information obtained by the operation of the in-vehicle device 10 using at least one of an image and a sound.

The acquisition unit 14 includes one or more receivers corresponding to any satellite positioning system. For example, the acquisition unit 14 includes a Global Positioning System (GPS) receiver. The acquisition unit 14 acquires, as position information, a measurement value of the position of the vehicle on which the in-vehicle device 10 is mounted. The location information includes, for example, an address, a latitude, a longitude, an altitude, and the like. The acquisition unit 14 may always acquire the position information of the vehicle or may periodically or non-periodically acquire the position information of the vehicle.

The control unit 15 includes a processor, a programmable circuit, a dedicated circuit, or any combination thereof. A processor is a general-purpose processor such as Central Processing Unit (CPU) or Graphics Processing Unit (GPU), or a special-purpose processor specialized for a particular process. The programmable circuitry is, for example, Field-Programmable Gate Array (FPGA). The control unit 15, which is, for example, Application Specific Integrated Circuit (ASIC), may include, for example, Electronic Control Unit (ECU). The control unit 15 is communicably connected to each component of the in-vehicle device 10, and executes processing related to the operation of the in-vehicle device 10 while controlling each component.

As illustrated in FIG. 1, the information processing apparatus 20 includes a communication unit 21, a storage unit 22, and a control unit 23.

The communication unit 21 includes a communication interface communicably connected to the network 30. The communication interface includes, for example, an interface compliant with a wired LAN communication standard such as Ethernet (registered trademark), a radio LAN communication standard such as IEEE 802.11, or a mobile communication standard such as LTE, 4G standard or 5G standard. In one embodiment, the information processing apparatus 20 is communicably connected to the network 30 via the communication unit 21. The communication unit 21 receives data used for the operation of the information processing apparatus 20 via the network 30, and transmits data obtained by the operation of the information processing apparatus 20.

The storage unit 22 includes, for example, a semiconductor memory, a magnetic memory, an optical memory, or any combination thereof. The storage unit 22 functions as, for example, a main storage device, an auxiliary storage device, or a cache memory. The storage unit 22 stores data used for the operation of the information processing apparatus 20 and data obtained by the operation of the information processing apparatus 20. For example, the storage unit 22 stores a system program, an application program, various types of data received or transmitted by the communication unit 21, and the like. The data stored in the storage unit 22 may be updatable by, for example, data received from the network 30 via the communication unit 21.

The control unit 23 includes a processor, a programmable circuit, a dedicated circuit, or any combination thereof. The processor is a general-purpose processor such as a CPU or a GPU, or a dedicated processor specialized for a specific process. The programmable circuit is, for example, an FPGA. The dedicated circuit is, for example, an ASIC. The control unit 23 is communicably connected to the constituent units constituting the information processing apparatus 20, and executes processing related to the operation of the information processing apparatus 20 while controlling the constituent units.

The control unit 23 receives, via the communication unit 21, information indicating that the vehicle speed is slow and the congestion is occurring from the vehicles involved in the congestion among the plurality of vehicles traveling in the first lane. The control unit 23 detects a traffic jam on the road based on the information acquired via the communication unit 21. The control unit 23 specifies the leading position and the trailing position of the traffic jam, and generates traffic jam information including these positions. The control unit 23 travels behind the traffic jam in the first lane, and notifies the vehicle that is not involved in the traffic jam via the communication unit 21 based on the traffic jam information that is generated to indicate that the traffic jam has occurred at the destination of the first lane.

Network 30 may include the Internet, Wide Area Network (WAN), Metropolitan Area Network (MAN), or any combination thereof. The network 30 may include a wireless network, an optical network, or any combination thereof. The wireless network is, for example, an ad hoc network, a cellular network, a wireless LAN, a satellite communication network, or a terrestrial microwave network.

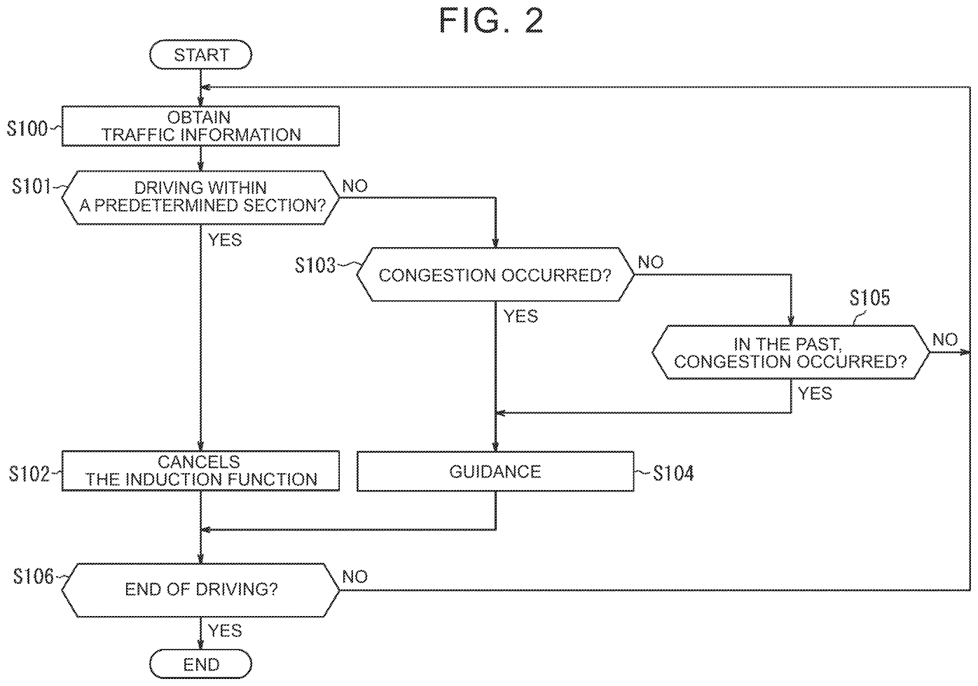

FIG. 2 is a flowchart for explaining an example of an information processing method executed by the in-vehicle device 10 of FIG. 1. An example of an information processing method executed by the in-vehicle device 10 of FIG. 1 will be described with reference to FIG. 2. The process illustrated in the flowchart of FIG. 2 is repeatedly executed while the vehicle on which the in-vehicle device 10 is mounted is traveling.

In S100, the control unit 15 of the in-vehicle device 10 acquires traffic congestion data for each lane on a road having a plurality of lanes. For example, the control unit 15 receives the congestion information from the information processing apparatus 20 via the network 30 and the communication unit 11 when the vehicle equipped with the in-vehicle device 10 is traveling in the distribution area of the information by the traffic control center that manages the information processing apparatus 20. The traffic jam information is simultaneously distributed by the traffic control center to a plurality of traveling vehicles. The control unit 15 stores the congestion data acquired in S100 in the storage unit 12.

In S101, the control unit 15 of the in-vehicle device 10 determines whether or not the vehicle is traveling in the predetermined section from the exit in the first lane that leads to the exit from the road. For example, the control unit 15 calculates the traveling position of the vehicle on which the in-vehicle device 10 is mounted based on the position information acquired by the acquisition unit 14 of the in-vehicle device 10, and executes S101 determination process.

The control unit 15 of the in-vehicle device 10 reads the second information out of the congestion information acquired in S100 from the storage unit 12. The control unit 15 calculates a predetermined section by multiplying the maximum distance from the exit of the traffic jam obtained based on the read second information by a predetermined ratio. For example, the predetermined section is calculated by a 90th percentile value or the like with respect to a past actual value regarding the maximum distance from the exit of the traffic jam obtained based on the second information. For example, in S101, the control unit 15 determines whether or not the vehicle travels within x (km) from the exit in the first lane that leads to the exit from the road.

When the control unit 15 of the in-vehicle device 10 determines that the vehicle is traveling in the predetermined section, S102 process is executed. When the control unit 15 determines that the vehicle is not traveling in the predetermined section, that is, is traveling outside the predetermined section, it executes S103 process.

In S102, when the vehicle travels in the predetermined section from the outlet in the first lane connected to the outlet from the road, the control unit 15 of the in-vehicle device 10 releases the guidance function. In the present disclosure, the “guidance function” includes, for example, a function of guiding vehicles to other lanes based on traffic congestion information acquired in S100. The control unit 15 has a guidance function and exerts a guidance function in a normal state, but when it is determined that the vehicles are traveling in a predetermined section in S101, the guidance function is turned off. At this time, the control unit 15 may output the fact that the guidance function is turned off and the reason thereof as information via the output unit 13 and notify the occupant in the vehicle cabin of the vehicle.

In S103, the control unit 15 of the in-vehicle device 10 determines whether or not a traffic jam has occurred in the first lane that leads to an exit from the roadway. For example, the control unit 15 reads the first information out of the congestion information acquired in S100 from the storage unit 12. The control unit 15 determines whether or not a traffic jam has occurred in the first lane from the middle toward the exit based on the read first information. The control unit 15 determines whether or not a traffic jam has occurred from an arbitrary position between the current position and the exit of the vehicle in the first lane, based on the read first information.

When determining that a traffic jam has occurred in the first lane, the control unit 15 of the in-vehicle device 10 executes S104 process. When determining that no traffic jam has occurred in the first lane, the control unit 15 executes S105 process.

In S104, when the control unit 15 of the in-vehicle device 10 determines that a traffic jam has occurred in the first lane from the middle toward the outlet, based on the first information, S103 guides the vehicle traveling outside the predetermined section from the first lane to the second lane. In the present disclosure, the “second lane” is, for example, a lane different from the first lane, and may be one lane adjacent to the first lane, or may be two or more lanes adjacent to the first lane. The control unit 15 performs the above-described guidance function in S104.

For example, the control unit 15 may prompt the driver driving the vehicle to change the lane from the first lane to the second lane via the output unit 13. For example, the control unit 15 may perform control such that the vehicle changes the lane from the first lane to the second lane in the travel of the vehicle in which the driving is automated.

In S105, the control unit 15 of the in-vehicle device 10 determines whether or not a traffic jam has occurred in the first lane that leads to an exit from the roadway. For example, the control unit 15 reads out the second information from the congestion information acquired in S100 from the storage unit 12. The control unit 15 determines whether or not a traffic jam has occurred in the past from the middle toward the exit in the first lane, based on the read second information. The control unit 15 determines whether or not a traffic jam has occurred in the past from an arbitrary position between the current position and the exit of the vehicle in the first lane, based on the read second information.

When the control unit 15 of the in-vehicle device 10 determines that a congestion has occurred in the first lane, S104 process is executed. When determining that no congestion has occurred in the first lane, the control unit 15 executes S100 process again.

In S104, the control unit 15 of the in-vehicle device 10 guides the vehicle traveling outside the predetermined section from the first lane to the second lane, when it is determined by S105 that the congestion has occurred in the past based on the second information, even if it is determined by S103 based on the first information that the congestion has not occurred from the way toward the outlet in the first lane. The control unit 15 performs the above-described guidance function in S104.

For example, the control unit 15 may prompt the driver driving the vehicle to change the lane from the first lane to the second lane via the output unit 13. For example, the control unit 15 may perform control such that the vehicle changes the lane from the first lane to the second lane in the travel of the vehicle in which the driving is automated.

In S106, the control unit 15 of the in-vehicle device 10 determines, for example, whether or not the vehicle in which the in-vehicle device 10 is mounted is stopped and the traveling is completed. When the control unit 15 determines that the traveling has ended, the process ends. When the control unit 15 determines that the traveling has not been completed, S100 process is executed again.

According to the in-vehicle device 10 according to the embodiment as described above, it is possible to suppress erroneous lane change guidance even when the current congestion information acquired by the in-vehicle device 10 is not accurate. When the vehicle travels within a predetermined section from the exit in the first lane leading to the exit from the road, the in-vehicle device 10 releases the guidance function. As a result, the lane change is avoided for the vehicle traveling in the predetermined section regardless of whether or not a traffic jam occurs so as to block the exit as an actual situation. Even if the leading position of the traffic jam included in the traffic jam information distributed from the traffic control center is false, the vehicle is not guided to the other second lane while traveling in the first lane. As a result, the in-vehicle device 10 can prevent the vehicle from returning to the first lane after the lane change and passing through the exit.

The in-vehicle device 10 releases the guidance function for avoiding the traffic jam in a predetermined case, considering the influence on the route plan of the vehicle due to the inability to return to the original first lane. Even in a case where the leading position and the trailing position of the traffic jam greatly change immediately after the occurrence of the traffic jam, the in-vehicle device 10 can suppress a situation in which the vehicle cannot return to the first lane by the exit of the vehicle descending regardless of the deviation between the traffic jam information from the traffic control center and the actual situation.

The in-vehicle device 10 acquires the congestion information including the current first information and the second information on the same day of the week and the same time in the past, and thus can more accurately exhibit the function of guiding the vehicle to another lane based on the two pieces of information in the current and past. For example, even in a case where a traffic jam does not occur based on the first information received from the traffic control center, if the occurrence of the traffic jam is indicated by the past second information, there is a possibility that the first information and the actual situation are deviated from each other and the traffic jam is currently occurring. In this way, even when the current congestion information acquired by the in-vehicle device 10 from the information processing apparatus 20, that is, the first information is not accurate, the in-vehicle device 10 can more appropriately exhibit the guidance function based on the second information.

When the in-vehicle device 10 determines that a traffic jam has occurred in the first lane from the middle toward the exit, based on the first information, it guides the vehicle traveling outside the predetermined section from the first lane to the second lane. Thus, when the first information and the actual situation are matched and a traffic jam actually occurs in the first lane, the in-vehicle device 10 enables the vehicle to avoid the traffic jam in the first lane. Even in a case where the first information and the actual situation are deviated from each other and no traffic jam actually occurs in the first lane, it is easy for the vehicle to return to the first lane and get off the exit after the lane change.

The in-vehicle device 10 guides the vehicle traveling outside the predetermined section from the first lane to the second lane, when it is determined that the traffic jam has occurred in the past based on the second information, even if it is determined based on the first information that the traffic jam has not occurred from the way toward the exit in the first lane. Accordingly, when the first information and the actual situation are deviated from each other and a traffic jam actually occurs in the first lane, the in-vehicle device 10 enables the vehicle to avoid the traffic jam in the first lane. Even when the first information is aligned with the actual situation and no traffic jam actually occurs in the first lane, it is easy for the vehicle to return to the first lane and get off the exit after the lane change.

The in-vehicle device 10 calculates a predetermined section by multiplying the maximum distance from the exit of the traffic jam obtained based on the second information by a predetermined ratio. As a result, the in-vehicle device 10 can more appropriately calculate the predetermined section in which the guidance function is to be turned off based on the past performance data. For example, if the predetermined section is longer than necessary, the guidance function of the in-vehicle device 10 may not be appropriately performed in some cases. On the other hand, when the predetermined section is shorter than necessary, the vehicle is changed in lane in order to avoid a traffic jam, but the vehicle cannot return to the original first lane by the branch point to the exit, and as a result, the vehicle cannot get off the exit. The in-vehicle device 10 can more appropriately calculate a predetermined section so that these problems are suppressed.

Although the present disclosure has been described with reference to the drawings and embodiments, it is noted that various changes and modifications can be made by those skilled in the art based on the present disclosure. It should be noted, therefore, that these modifications and alterations are within the scope of the present disclosure. For example, the functions, etc. included in the configurations, steps, or the like can be rearranged so as not to be logically inconsistent, and a plurality of configurations, steps, or the like can be combined into one or divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, at least a part of the processing operations executed in the in-vehicle device 10 in the above-described embodiment may be executed in the information processing apparatus 20. For example, instead of the in-vehicle device 10, the information processing apparatus 20 itself may execute the above-described series of processing operations related to the in-vehicle device 10. In this case, the information processing apparatus 20 executes each step in the above-described flowchart while transmitting and receiving information necessary for processing to and from the in-vehicle device 10.

Conversely, at least a part of the processing operations executed in the information processing apparatus 20 may be executed in the in-vehicle device 10.

For example, a general-purpose electronic device such as a smartphone or a computer can be configured to function as the in-vehicle device 10 according to the above-described embodiment. Specifically, a program describing processing contents for realizing each function of the in-vehicle device 10 and the like according to the embodiment is stored in a memory of the electronic device, and the program is read and executed by a processor of the electronic device. Thus, the disclosure according to the embodiment can also be realized as the program that can be executed by the processor.

Alternatively, the disclosure according to an embodiment may also be implemented as a non-transitory computer-readable medium storing a program executable by one or more processors to cause the in-vehicle device 10 or the like according to the embodiment to execute each function. It should be understood that the above configurations are also included in the scope of the present disclosure.

The program can be stored on a non-transitory computer-readable medium. The non-transitory computer-readable medium is, for example, a flash memory, a magnetic recording device, an optical disk, a magneto-optical recording medium, or a Read Only Memory (ROM). Distribution of the program is performed, for example, by selling, transferring, or lending a portable medium such as a Secure Digital (SD) card, Digital Versatile Disc (DVD), or Compact Disc Read Only Memory (CD-ROM) storing the program. The program may be distributed by being stored in a storage of the server and transferred from the server to another computer. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The process may be executed by a so-called Application Service Provider (ASP) type service that realizes a function only by an execution instruction and a result-acquisition, without transferring a program from a server to a computer. The program includes information that is used for processing by electronic computers and equivalent to a program. For example, data that is not a direct command to a computer but has the property of defining the processing of the computer corresponds to the “data equivalent to a program”.

Some or all of the functions of the in-vehicle device 10 may be realized by a programmable circuit or a dedicated circuit as the control unit 15. That is, some or all of the functions of the in-vehicle device 10 may be realized by hardware.

In the above-described embodiment, the control unit 15 of the in-vehicle device 10 acquires the congestion information including the current first information and the second information on the same day of the week and the same time in the past. The control unit 15 of the in-vehicle device 10 may acquire the congestion information including only one of the first information and the second information.

In the above-described embodiment, the control unit 15 of the in-vehicle device 10 has been described as guiding the vehicle traveling outside the predetermined section from the first lane to the second lane when it is determined on the basis of the first information that a traffic jam has occurred in the first lane from the middle toward the exit, but the present disclosure is not limited thereto. The control unit 15 of the in-vehicle device 10 may guide the vehicle from the first lane to the second lane based on the presence or absence of the traffic jam and also the tail position of the traffic jam further included in the first information.

For example, the control unit 15 may guide the vehicle from the first lane to the second lane when it is determined that the end position of the traffic jam is located closer to the vehicle than the predetermined reference position and the distance of the traffic jam is long. Conversely, when the control unit 15 determines that the trailing position of the traffic jam is located closer to the exit side than the predetermined reference position and the distance of the traffic jam is short, it is not necessary to guide the vehicle from the first lane to the second lane.

The control unit 15 may determine whether or not to guide the vehicle from the first lane to the second lane while referring to the end position of the past congestion included in the second information in addition to or instead of the end position of the congestion included in the first information.

In the above-described embodiment, the control unit 15 of the in-vehicle device 10 has been described as guiding the vehicle traveling outside the predetermined section from the first lane to the second lane when it is determined that the traffic jam has occurred in the past based on the second information even if it is determined based on the first information that the traffic jam has not occurred from the middle toward the exit in the first lane, but the present disclosure is not limited thereto. For example, in a case where the congestion information including only the first information is acquired, the control unit 15 may not execute the processing based on the second information.

In the above-described embodiment, the control unit 15 of the in-vehicle device 10 calculates the predetermined section by multiplying the maximum distance from the exit of the congestion obtained based on the second information by a predetermined ratio, but the present disclosure is not limited thereto. The control unit 15 may determine the predetermined section based on the value of the distance from the exit set by the user including the driver.

A part of the embodiment of the present disclosure is shown as an example below. However, it should be noted that embodiment of the present disclosure is not limited to these.

### Appendix 1

An in-vehicle device mounted on a vehicle includes a control unit having a function of acquiring traffic congestion information for each lane on a road with a plurality of lanes and guiding the vehicle to another lane based on the acquired traffic congestion information. The control unit cancels the function when the vehicle travels within a predetermined section from an exit in a first lane that leads to the exit from the road.

### Appendix 2

In the in-vehicle device according to Appendix 1, the control unit acquires the traffic congestion information including a current first information and second information of the same day of the week and the same time of the past.

### Appendix 3

In the in-vehicle device according to Appendix 2, when the control unit determines based on the first information that a traffic congestion has occurred partway through the first lane toward the exit, the control unit guides, from the first lane to a second lane, the vehicle traveling outside the predetermined section.

### Appendix 4

In the in-vehicle device according to any one of Appendices 2 and 3, even when the control unit determines based on the first information that a traffic congestion has not occurred partway through the first lane toward the exit, when the control unit determines based on the second information that a traffic congestion has occurred in the past, the control unit guides, from the first lane to a second lane, the vehicle traveling outside the predetermined section.

### Appendix 5

In the in-vehicle device according to any one of Appendices 2 to 4, the control unit calculates the predetermined section by multiplying a maximum distance of the traffic congestion from the exit by a predetermined ratio, the maximum distance being a value acquired based on the second information.

What is claimed is:

1. An in-vehicle device mounted on a vehicle, the in-vehicle device comprising a control unit having a function of acquiring traffic congestion information for each lane on a road with a plurality of lanes and guiding the vehicle to another lane based on the acquired traffic congestion information, wherein the control unit cancels the function when the vehicle travels within a predetermined section from an exit in a first lane that leads to the exit from the road.

2. The in-vehicle device according to claim 1, wherein the control unit acquires the traffic congestion information including a current first information and second information of the same day of the week and the same time of the past.

3. The in-vehicle device according to claim 2, wherein when the control unit determines based on the first information that a traffic congestion has occurred partway through the first lane toward the exit, the control unit guides, from the first lane to a second lane, the vehicle traveling outside the predetermined section.

4. The in-vehicle device according to claim 2, wherein even when the control unit determines based on the first information that a traffic congestion has not occurred partway through the first lane toward the exit, when the control unit determines based on the second information that a traffic congestion has occurred in the past, the control unit guides, from the first lane to a second lane, the vehicle traveling outside the predetermined section.

5. The in-vehicle device according to claim 2, wherein the control unit calculates the predetermined section by multiplying a maximum distance of the traffic congestion from the exit by a predetermined ratio, the maximum distance being a value acquired based on the second information.
